(19) United States
(12) Patent Application Publication
(10) Pub. No.: US 2014/0258038 A1
(43) Pub. Date: Sep. 11, 2014

(54) Systems and Methods for Identifying Information about Objects

(71) Applicant: WORTHPOINT CORPORATION, Atlanta, GA (US)

(72) Inventor: William Seippel, Atlanta, GA (US)

(73) Assignee: WORTHPOINT CORPORATION, Atlanta, GA (US)

(21) Appl. No.: 13/787,484

(22) Filed: Mar. 6, 2013

(51) Int. Cl. G06Q 30/06

(52) U.S. Cl. CPC G06Q 30/0623
USPC 705/26.61

(57) ABSTRACT

A system according to particular embodiments is adapted for identifying a maker's mark on a particular object and to then display information regarding the maker's mark to a user. The system is configured to receive an image of a maker's mark on an object, identify the maker's mark, and then retrieve information relating to the maker's mark. Such information may include information regarding the name of a particular maker associated with the maker's mark, the time period in which the maker produced objects, the geographic area in which the maker worked or works, other types of work with which the maker is associated, valuations of works by the maker, and/or any other information related to the maker or the object.

### BACKGROUND

Various objects (e.g., ceramics, metalworks, glasswork, etc.) are often marked with a Maker's Mark by their creators in order to identify the objects as those of the creator. Certain people may desire to learn information about an object and the object's maker. Accordingly, there is a need for systems and methods for identifying such information.

### SUMMARY OF VARIOUS EMBODIMENTS

A computer system, according to particular embodiments, comprises at least one processor and memory. In various embodiments, the computer system may be configured for: receiving, from a computing device associated with a user, an image of at least a portion of an object, the at least a portion of the object comprising at least a portion of a particular indicium and analyzing the image to identify the at least a portion of the particular indicium on the at least a portion of said object. In particular embodiments, at least partially in response to identifying the at least a portion of the particular indicium, the computer system may be configured for retrieving information associated with the particular indicium; and displaying the information to the user.

A non-transitory computer-readable medium, according to particular embodiment, stores computer executable instructions for: (A) receiving an image taken by a mobile device associated with a user, the image comprising at least a portion of an object; (B) using the image to identify a particular maker's mark on the at least a portion of the object; (C) after identifying the particular maker's mark, using an identification of the particular maker's mark to retrieve information associated with the object; and (D) displaying the information to the user.

### BRIEF DESCRIPTION OF THE DRAWINGS

Having thus described various embodiments in general terms, reference will now be made to the accompanying drawings, which are not necessarily drawn to scale, and wherein:

FIG. 1 is a block diagram of a Maker's Mark Identifying System according to one embodiment.

FIG. 2 is a block diagram of a Maker's Mark Identifying Server of FIG. 1.

FIG. 3 is a flowchart showing steps executed by a Maker's Mark Identifying Module according to a particular embodiment.

FIG. 4 is a screen display of an exemplary Maker's Mark Identifying System for a mobile device.

FIG. 5 is a screen display of an exemplary Maker's Mark Identifying System capturing an image of a maker's mark.

### DETAILED DESCRIPTION OF VARIOUS EMBODIMENTS

Various embodiments now will be described more fully hereinafter with reference to the accompanying drawings. It should be understood that the invention may be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

Overview

Computer systems and/or methods according to particular embodiments are adapted for identifying information associated with an object (e.g., a piece of metalwork, a ceramic, porcelain, or a piece of glasswork) based at least in part on an indicium on the object (or otherwise associated with the object). In particular embodiments, the indicium from which the system derives the identifying information may be a maker's mark, which may be, for example, an identifying mark that may be used by a maker of an object (e.g., which may include an individual, particular company, etc.) such as a metalwork, ceramic, porcelain, etc. to identify the work as their own. In addition to identifying the maker, information that may be derived about an object based on its maker's mark may include, for example, the time period in which the maker produced objects (e.g., the time period in which a particular silversmith associated with the maker's mark produced works of silver), the geographic area in which the maker worked or works, other types of work with which the maker is associated, and valuations of works produced by the maker (e.g., valuations from works of the maker that have been sold at auction or are available for sale, or any other information related to the maker of the object).

Exemplary Technical Platforms

As will be appreciated by one skilled in the relevant field, the present invention may be, for example, embodied as a computer system, a method, or a computer program product. Accordingly, various embodiments may take the form of an entirely hardware embodiment, an entirely software embodiment, or an embodiment combining software and hardware aspects. Furthermore, particular embodiments may take the form of a computer program product stored on a computer-readable storage medium having computer-readable instructions (e.g., software) embodied in the storage medium. Various embodiments may take the form of web-implemented computer software. Any suitable computer-readable storage medium may be utilized including, for example, hard disks, compact disks, DVDs, optical storage devices, and/or magnetic storage devices.

Various embodiments are described below with reference to block diagrams and flowchart illustrations of methods, apparatuses (e.g., systems) and computer program products. It should be understood that each block of the block diagrams and flowchart illustrations, and combinations of blocks in the block diagrams and flowchart illustrations, respectively, can be implemented by a computer executing computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

These computer program instructions may also be stored in a computer-readable memory that can direct a computer or other programmable data processing apparatus to function in a particular manner such that the instructions stored in the computer-readable memory produce an article of manufacture that is configured for implementing the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Accordingly, blocks of the block diagrams and flowchart illustrations support combinations of mechanisms for performing the specified functions, combinations of steps for performing the specified functions, and program instructions for performing the specified functions. It should also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and other hardware executing appropriate computer instructions.

Exemplary System Architecture

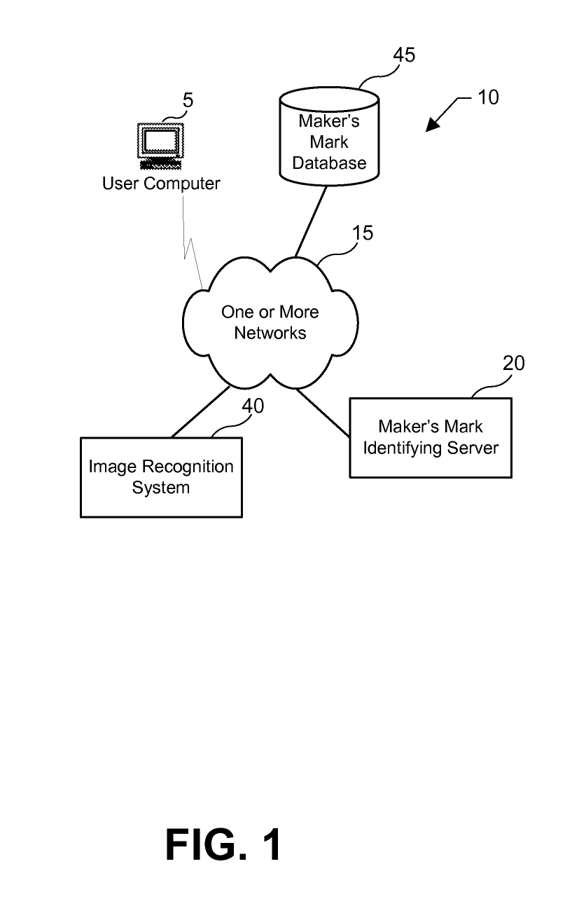

FIG. 1 shows a block diagram of a Maker's Mark Identifying System 10 according to a particular embodiment. As may be understood from this figure, the Maker's Mark Identifying System 10 includes at least one User Computer 5 (e.g., a tablet computer, smart phone, laptop, or other suitable User Computer), one or more computer networks 15, a Maker's Mark Identifying Server 20, an Image Recognition System 40, and a Maker's Mark Database 45. The one or more computer networks 15 facilitate communication between the User Computer 5, Maker's Mark Identifying Server 20, Image Recognition System 40, and Maker's Mark Database 45. These one or more computer networks 15 may include any of a variety of types of computer networks such as the Internet, a private intranet, a public switch telephone network (PSTN), or any other type of network known in the art. In certain variations of the embodiment shown in FIG. 1, both the communication link between the User Computer 5, Maker's Mark Identifying Server 20, Image Recognition System 40, and Maker's Mark Database 45 are implemented via the Internet using Internet protocol (IP). The communication link between the Maker's Mark Identifying Server 20 and the Maker's Mark Database 45 may be, for example, implemented via a Local Area Network (LAN).

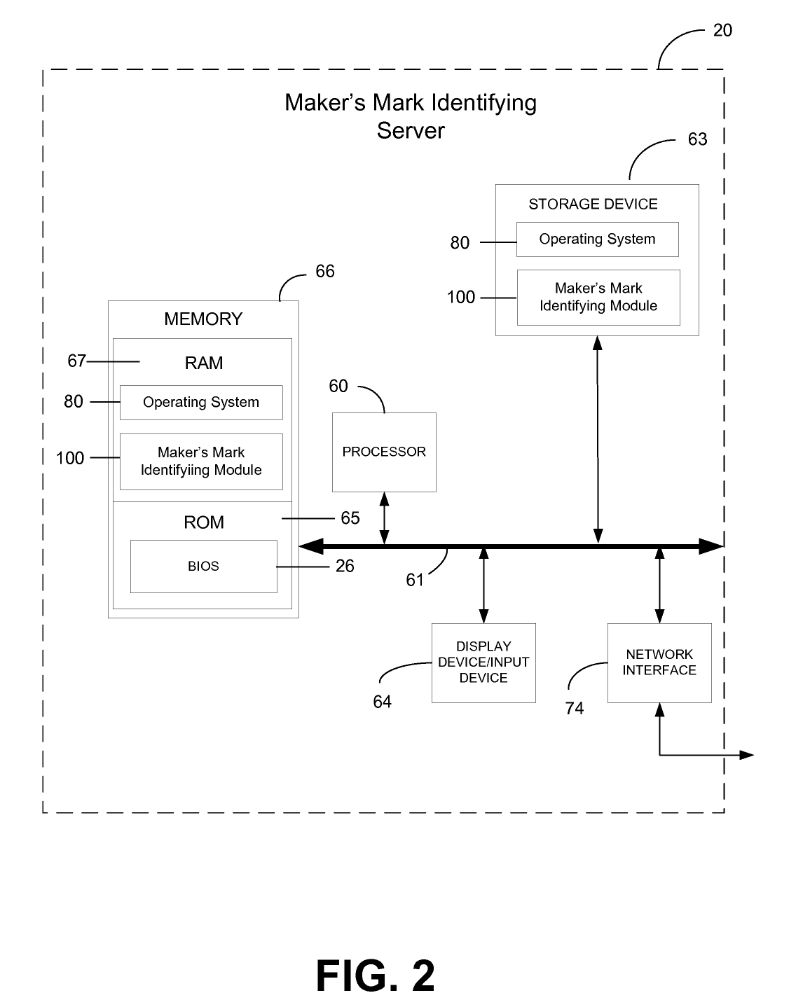

FIG. 2 shows a block diagram of an exemplary embodiment of the Maker's Mark Identifying Server 20 of FIG. 1. The Maker's Mark Identifying Server 20 includes a processor 60 that communicates with other elements within the Maker's Mark Identifying Server 20 via a system interface or bus 61. Also included in the Maker's Mark Identifying Server 20 is a display device/input device 64 for receiving and displaying data. This display device/input device 64 may be, for example, a keyboard, voice recognition, or pointing device that is used in combination with a monitor. The Maker's Mark Identifying Server 20 further includes memory 66, which preferably includes both read only memory (ROM) 65 and random access memory (RAM) 67. The server's ROM 65 is used to store a basic input/output system 26 (BIOS) that contains the basic routines that help to transfer information between elements within the Maker's Mark Identifying Server 20.

In addition, the Maker's Mark Identifying Server 20 includes at least one storage device 63, such as a hard disk drive, a floppy disk drive, a CD Rom drive, or optical disk drive, for storing information on various computer-readable media, such as a hard disk, a removable magnetic disk, or a CD-ROM disk. As will be appreciated by one of ordinary skill in the art, each of these storage devices 63 is connected to the system bus 61 by an appropriate interface. The storage devices 63 and their associated computer-readable media provide nonvolatile storage for the Maker's Mark Identifying Server 20. It is important to note that the computer-readable media described above could be replaced by any other type of computer-readable media known in the art. Such media include, for example, magnetic cassettes, flash memory cards, digital video disks, and Bernoulli cartridges.

A number of program modules may be stored by the various storage devices and within RAM 67. Such program modules include an operating system 80 and a Maker's Mark Identifying Module 100. The Maker's Mark Identifying Module 100 controls certain aspects of the operation of the Maker's Mark Identifying Server 20, as is described in more detail below, with the assistance of the processor 60 and an operating system 80.

Also located within the Maker's Mark Identifying Server 20 is a network interface 74 for interfacing and communicating with other elements of a computer network. It will be appreciated by one of ordinary skill in the art that one or more of the Maker's Mark Identifying Server 20 components may be located geographically remotely from other Maker's Mark Identifying Server 20 components. Furthermore, one or more of the components may be combined, and additional components performing functions described herein may be included in the Maker's Mark Identifying Server 20.

### Exemplary System Modules

As noted above, various aspects of the system's functionality may be executed by certain system modules, including the system's Maker's Mark Identification Module 100. This module is discussed in greater detail below.

Maker's Mark Identification Module

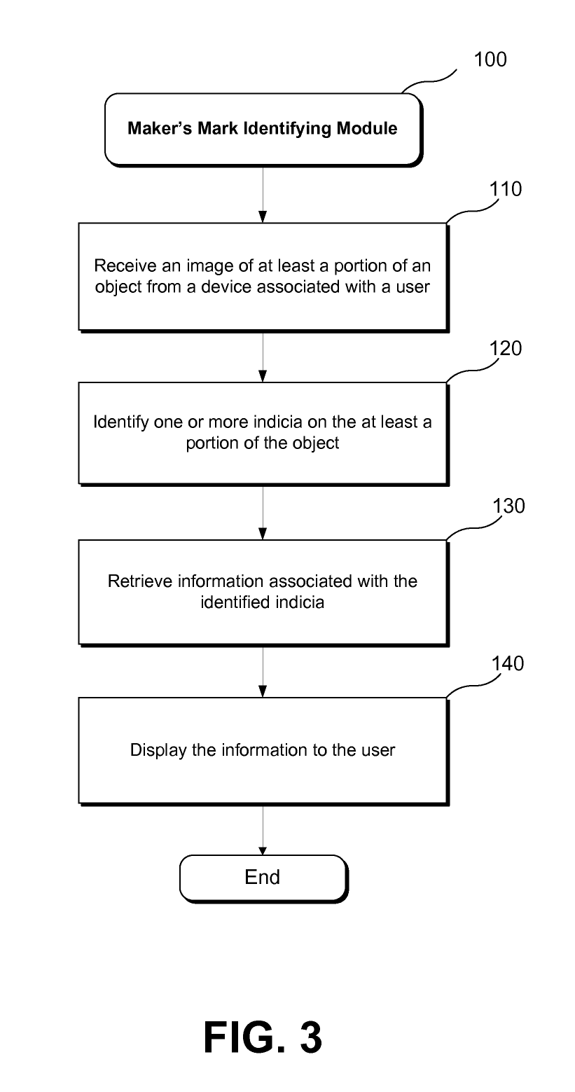

FIG. 3 is a flow chart of an exemplary Maker's Mark Identification Module 100. As may be understood from FIG. 3, certain embodiments of the Maker's Mark Identification Module 100 are configured to identify a maker's mark on an object (e.g., a collectable item, such as a piece of metalwork, a ceramic, porcelain, a piece of glasswork, or any antique item). For example, beginning at Step 110, the Maker's Mark Identification Module 100 may receive an image of at least a portion of an object from a device associated with a user. The device associated with the user may include, for example, a tablet computer, a handheld device such as a smart phone, a laptop computer, a camera, or other suitable device for capturing an image. The system may receive the image, for example, via a camera associated with the device associated with the user (e.g., the built in camera of a smartphone, tablet or laptop). In various embodiments, the system may receive an image taken at any time by any suitable image taking device (e.g., the user may take a photographic image using a digital camera, download the image from a storage device of the digital camera to a computer associated with the user, and then send the image to the system).

The system continues, at Step 120, by identifying one or more indicia on the at least a portion of the object. The indicia may include, for example, a maker's mark. The system may identify the maker's mark, for example, by comparing the mark to an existing database of maker's marks. The system may perform this comparison through any suitable image recognition system or similar system. In various embodiments, the existing database of maker's marks may comprise graphical representations of various maker's marks. These graphical representations may be, for example, hand drawn and/or may include images of makers marks displayed on one or more items. In other embodiments, the graphical representations may be computer generated (e.g., from images of known maker's marks).

In particular embodiments, the system may identify the maker's mark by comparing the maker's mark in the image received at Step 110 with a database of images of known maker's marks. In various embodiments, the system may require a particular level of certainty in a comparison in order to identify the image captured at Step 110. For example, the system may require a confidence level such as a confidence level above 70% in order to identify the indicium as a particular maker's mark. In various embodiments, this confidence level may be determined based, at least in part, on how closely the maker's mark in the image matches a particular maker's mark in the database of maker's marks. For example, the system may assign a confidence level of 70% to a match between a photographed maker's mark and a mark in the maker's mark database if the photographed image includes at least 70% of the maker's mark that is stored in the database. Accordingly, it should be understood that the system may be adapted to identify incomplete maker's marks. For example, particular objects may comprise partial maker's marks (e.g., maker's marks that are partially worn off of the object or partial maker's marks that are present on works that may be broken or damaged).

Turning again to FIG. 3, the system continues at Step 130 by retrieving information associated with the one or more indicia (e.g., the maker's mark) identified at Step 120. The information may include, for example: (1) information about a maker associated with the identified maker's mark such as the time period in which the maker produced objects (e.g., the time period in which a particular silversmith associated with the maker's mark produced works of silver); (2) the geographic area in which the maker worked or works, other types of work with which the maker is associated; (3) valuations of works by the maker (e.g., valuations of works of the maker that have been sold at auction or that are currently available for sale); (4) a description of the mark itself (e.g., “the mark includes an arrow with a circle in the middle”); (5) the manner in which the identified maker's mark was typically applied to objects (e.g., impressed, stamped, painted, carved, etc.); (6) information about whether the maker had any successors that produced work under the same or similar marks; and/or (7) any other information related to the maker of the object or the maker's mark itself.

Finally, at Step 140, the system displays the information retrieved at Step 130 to the user, for example, by displaying the information on a screen of the device associated with the user from which the system received the image of the object. In particular embodiments, the system may be adapted to display the information to the user by sending the user an electronic message (e.g., an e-mail, SMS, text message, or other suitable message), containing the information.

### Exemplary Use

The system may be utilized for any suitable purpose. A user may, for example, be interested in purchasing a particular ceramic work. Before purchasing the ceramic work, the user may desire to know information about the work such as information about the maker of the work (e.g., to ensure that the ceramic work is authentic, to determine if the work is worth the particular price being charged for the work, or for any other suitable reason).

In order to ascertain information about the ceramic work, the user may take an image of an identifying mark on the ceramic work. In a particular embodiment, the user may do this by first executing an “app” on a mobile computing device associated with the user, and then taking a photograph, within the context of the app, with a built in camera on the user's mobile computing device). The identifying mark may include, for example, a stamp, carving or other symbol on the ceramic work (e.g., on an exterior portion of the ceramic work's base). A Maker's Mark Identifying System may then receive from the user, at Step 110, the image of the ceramic work containing the identifying mark. The System may then, at Step 120, identify the identifying mark, for example, by comparing the identifying mark to a database of known marks. In particular embodiments, the System may identify the mark using any suitable image comparing software or technique (e.g., to compare the image of the identifying mark to the database of known marks such that the System identifies the identifying mark as a known mark).

The System may then, at Step 130, retrieve information associated with the identified identifying mark. This information may include, for example: (1) information relating to the identity of the maker of the ceramic work (e.g., the artist or craftsman who produced the work); (2) information about the geographic original of the work (e.g., a particular city or region in which works bearing the particular identifying mark were produced); and/or (3) any other suitable information relating to the identifying mark (e.g., information about the mark itself or information derived about the ceramic work as a result of the ceramic work having been marked with the particular identifying mark).

As a particular example, a particular ceramic work may bear a particular identifying mark that is associated with a maker. By identifying the particular maker associated with the identifying mark on the ceramic work, the System may be able to retrieve information about the ceramic work itself. For example, particular makers may have worked with particular materials (e.g., particular varieties of clay) or utilized particular techniques (e.g., particular types of kilns) in creating their works. The system finally, at Step 140, displays the information retrieved at Step 130 to the user. In particular embodiments, the System may display the information on the mobile computing device with which the user took the image of the identifying mark.

### Exemplary User Experience

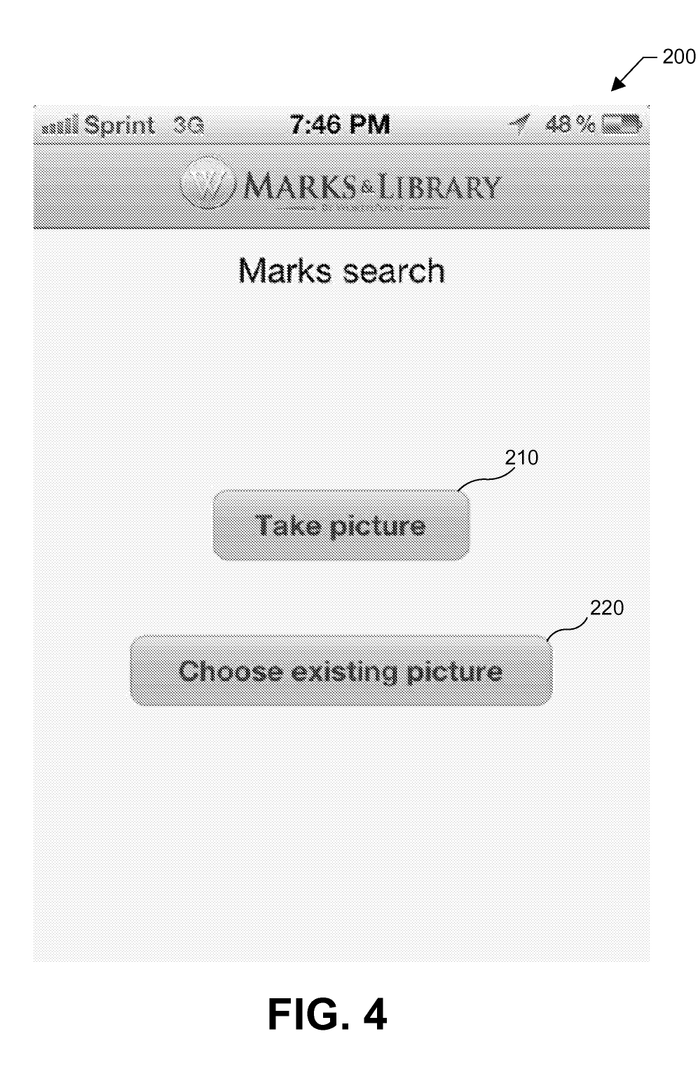

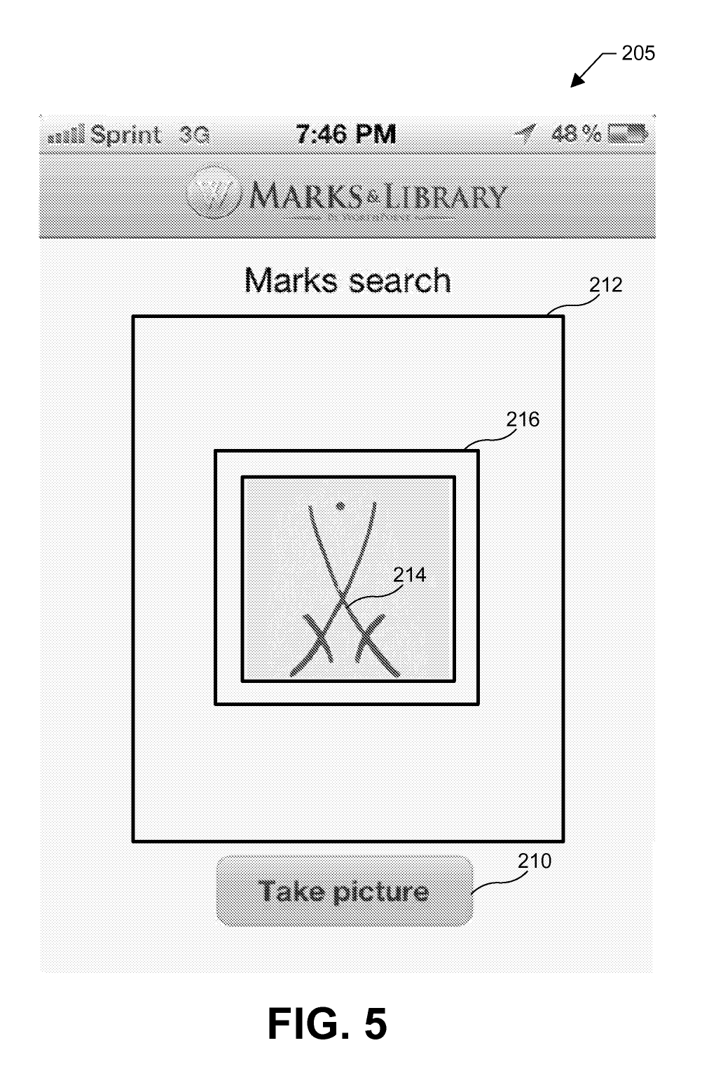

A user may access a Maker's Mark Identifying System using any suitable computing device (e.g., a mobile computing device such as a tablet computer or handheld computing device, or other suitable computing device). FIGS. 4 and 5 depict screen displays of an exemplary user interface of a Maker's Mark Identifying System. FIG. 4 depicts an exemplary user interface 200 of a Maker's Mark Identifying Application, which may, for example, be executed on a handheld computing device. When using the application, a user may direct the system to take a picture (e.g., of a maker's mark) by activating a Take Picture 210 button. Alternatively, the user may select an existing picture (e.g., a picture stored on the user's handheld computing device) by activating a Choose Existing Picture 220 button.

In particular embodiments, when selecting the Take Picture 210 button, the system takes the user to a picture taking interface 205 (see FIG. 5) where the user can take a picture of a maker's mark 214 for identification by the system (e.g., using a built in camera associated with the user's handheld computing device). The user may direct the handheld device's camera toward the maker's mark that the user wishes to identify. In particular embodiments, the user interface includes a preview window 212 that displays a substantially current (e.g., current) view of whatever the camera is directed toward (e.g., a preview of what the camera would capture an image of if it were to take a photograph at that time). In various embodiments, the system is configured to at least substantially automatically (e.g., automatically) detect any maker's mark 214 that is contained within the preview window 212. In particular embodiments, the system highlights any detected maker's mark 214 with an indicium 216 (e.g., by displaying a square or other suitable indicia around the detected maker's mark 214). Once the system has highlighted a detected maker's mark 214, the user may select the Take Photograph 210 button to initiate the system to retrieve information associated with the mark.

In particular embodiments, when selecting the Choose Existing Picture 220 button, the user selects an existing picture of a maker's mark for the system to identify. The existing picture may be located, for example, on a storage device associated with the user's handheld device (e.g., smart phone). The existing picture may have been taken by the handheld device at an earlier time, or it may have been taken by a different device (e.g., a digital camera) and sent to the user's handheld device (e.g., via e-mail). In various embodiments, the system displays any available existing pictures from which the user may choose as thumbnails (e.g., reduced sized versions of the pictures) on a display screen associated with the user's handheld device. In particular embodiments, the user may select the thumbnail of the picture containing a maker's mark that the user wishes to identify, and, at least partially in response to the user selecting the picture, the system identifies the maker's mark within the picture, and then displays any information retrieved about the mark on the mobile device's screen.

### Other Suitable Uses

Valuating Items

In particular embodiments, the system may be utilized to track and valuate certain items of personal property. Collectors, for example, may utilize the system to create a database of collectible items in their possession in order to track the value of those items over time. Users may use a Maker's Mark Identifying System to populate portfolios of items whose value may, for example, be tracked using a system for valuating and tracking items of property, such as the system described in U.S. patent application Ser. No. 12/560,666 entitled “Systems for Valuating and Tracking Items of Property”, which was filed Sep. 16, 2009, and which is hereby incorporated herein by reference in its entirety.

Constructing a Taxonomy

In particular embodiments, the system may be adapted for classifying items into a taxonomy. For example, the system may be used in association with a system for maintaining and interactively constructing a taxonomy, such as the system described in U.S. patent application Ser. No. 12/706,691 entitled “Systems and Methods for Maintaining and Interactively Constructing a Taxonomy,” filed Feb. 16, 2010, which is hereby incorporated herein by reference in its entirety. Various embodiments of the maker's mark identifying system may be used in association with a system for constructing a taxonomy, for example, by retrieving information about an item for use in classifying the item into particular classes or subclasses. A particular subclass of a taxonomy, for example, may include an item's maker.

In a particular example, a hand-made piece of Native American pottery that bears the mark of a particular maker may have a taxonomy comprising the following nodes: Ceramics Pottery Native American Hand-made “Name of Maker”. Where the “Name of Maker” is a particular Native American artist. In particular embodiments, a taxonomy for a particular item may be substantially automatically constructed based on information retrieved by the maker's mark identifying system.

### Alternative Embodiments

Multiple Marks for Same Maker

In particular embodiments, the system may be adapted to identify a plurality of marks associated with the same particular maker. A maker, for example, may have utilized different maker's marks during different time periods (e.g., the maker modified their maker's mark at a particular point in time) or utilized different marks for different types of work (e.g., a maker may apply a first maker's mark to ceramic items and a second maker's mark to metalworks).

Addition of Maker's Marks to Database

In various embodiments, a user may attempt to identify a maker's mark that is not present in any available database of known marks. In such embodiments, the system may be adapted to receive information from the user (e.g., information about the mark such as an image of the mark itself, the maker with which the mark is identified, etc.), and to then add the maker's mark along with the information received form the user into the system's database of known marks.

User Confirmation of Mark Identity

In particular embodiments, the system may be adapted to display a mark that the system has identified as the mark in the image to the user before retrieving information associated with the mark. In such embodiments, the system may query the user to confirm that the identified mark matches the mark on the particular object. In response to the user confirming that the displayed mark matches the mark on the object, the system displays information regarding the mark. However, if the user indicates that the displayed mark doesn't match the mark on the object, the system may request that the user provide another picture of the mark and/or select another mark from a list of potential matching marks.

### CONCLUSION

Many modifications and other embodiments of the invention will come to mind to one skilled in the art to which this invention pertains having the benefit of the teachings presented in the foregoing descriptions and the associated drawings. While examples discussed above cover the use of the invention in the context of maker's mark identification, the invention may be used in any other suitable context. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for the purposes of limitation.

What is claimed is:

1. A computer system comprising:
at least one processor; and
memory, wherein said computer system is configured for:
(A) receiving, from a computing device associated with a user, an image of at least a portion of an object, said at least a portion of said object comprising at least a portion of a particular indicium;
(B) analyzing said image to identify said at least a portion of said particular indicium on said at least a portion of said object;
(C) at least partially in response to identifying said at least a portion of said particular indicium, retrieving information associated with said particular indicium; and
(D) displaying said information to said user.

2. The computer system of claim 1, wherein said identifying said at least a portion of said particular indicium comprises:
comparing said at least a portion of said particular indicium to multiple indicia within a database of known indicia; and
in response to determining that said at least a portion of said particular indicium matches at least a portion of at least one indicium within said database, identifying said particular indicium as said at least one indicium within said database.

3. The computer system of claim 2, wherein said database of known indicia comprises graphical representations of a plurality of different maker's marks.

4. The computer system of claim 3, wherein said graphical representations of maker's marks are at least substantially hand drawn.

5. The computer system of claim 3, wherein said graphical representations of maker's marks are at least substantially computer generated.

6. The computer system of claim 2, wherein said database of known indicia comprises images of said known indicia.

7. The computer system of claim 1, wherein said particular indicium comprises a maker's mark.

8. The computer system of claim 7, wherein said information includes a sale price of at least one other object comprising said maker's mark.

9. The computer system of claim 1, wherein said information includes information regarding a maker of said object.

10. The computer system of claim 9, wherein said information includes at least one year in which said maker produced objects.

11. The computer system of claim 1, wherein said object is selected from a group consisting of:
(A) a ceramic;
(B) a metalwork; and
(C) a glass work.

12. The computer system of claim 1, wherein said information includes information about the creation of said object.

13. A non-transitory computer-readable medium storing computer executable instructions for:
(A) receiving an image taken by a mobile device associated with a user, said image comprising at least a portion of an object;
(B) using said image to identify a particular maker's mark on said at least a portion of said object;
(C) after identifying said particular maker's mark, using an identification of said particular maker's mark to retrieve information associated with said object; and
(D) displaying said information to said user.

14. The non-transitory computer-readable medium of claim 13, wherein said information is selected from a group consisting of:
(A) information about a maker of said object;
(B) information about a time period in which said object was made;
(C) information about one or more valuations of other items bearing said particular maker's mark; and
(D) a description of said particular maker's mark.

15. The computer-readable medium of claim 13, wherein said instructions for identifying said particular maker's mark comprise instructions for identifying said particular maker's mark by determining at least a partial match between said particular maker's mark and a maker's mark within a database of known maker's marks.

16. A computer system comprising:
at least one processor; and
memory, wherein said computer system is configured for:
(A)receiving, from a computing device associated with a user, an image of at least a portion of an object, said at least a portion of said object comprising at least a portion of a maker's mark;
(B) comparing said at least a portion of said maker's mark to a plurality of maker's marks in a database of known maker's marks;
(C) identifying a particular one of said plurality of maker's marks in said database of known maker's marks that comprises said at least a portion of said maker's mark;
(D) retrieving information associated with said identified maker's mark; and
(E) displaying said information to said user.

17. The computer system of claim 16, wherein said information is selected from a group consisting of:
(A) information about a maker of said object;
(B) information about a time period in which said object was made;
(C) information about valuations of other items bearing said maker's mark; and
(D) a description of said maker's mark.

18. The computer system of claim 16, wherein said system is adapted to use said information to automatically construct a taxonomy for said object.
